(19) United States
(12) Patent Application Publication
(10) Pub. No.: US 2008/0169416 A1
(43) Pub. Date: Jul. 17, 2008

(54) APPARATUS AND METHOD FOR ANALYSING MOLECULES

(75) Inventors: Stephen Paul Thompson, Cheshire (GB); Victor Parr, Manchester (GB); Herschel Rabitz, Princeton, NJ (US)

Correspondence Address: BARLOW, JOSEPHS & HOLMES, LTD., 101 DYER STREET, 5TH FLOOR, PROVIDENCE, RI, 02903, US

(73) Assignee: PULSED INSTRUMENTS, INC., Princeton, NJ (US)

(21) Appl. No.: 11/623,797

(22) Filed: Jan. 17, 2007

(51) Int. Cl. B01D 59/44

(52) U.S. Cl. 250/286

(57) ABSTRACT

Apparatus for analysing molecules, including an ablation device 1,10 for releasing molecules from a sample, and a laser device 1,2,3 for illuminating released molecules with a shaped laser pulse thereby to ionize and/or dissociate the molecules. The ablation device or laser device has at least one component which is not shared by the other device. This enables the steps of ablation and ionization/dissociation to be separated. The ablation device may be means for generating an ion or neutral beam, or an unshaped laser pulse. The laser device may be a femtosecond shaped pulse laser. The ablation device may illuminate the sample with a beam and the laser device preferably produces a pulse shaped laser beam which is spaced part from the sample.

### BACKGROUND OF THE INVENTION

The present invention relates to an apparatus and method for analysing molecules.

The invention is particularly, although not exclusively, concerned with the analysis of complex molecules such as biomolecules. Complex molecules are typically those with a mass of 100 or more. A typical peptide molecule has a mass in the region of 2500.

Existing techniques for the analysis of complex molecules by mass spectrometry or a similar technique involve the use of an ion, neutral or laser beam to ablate molecules from the surface of a sample and ionize the molecules so that they can be swept into a mass spectrometer or other analyser. The use of these beams is, however, very inefficient in terms of ionizing released molecules. Generally the proportion of molecules released from a sample which is ionized is of the order of one in 1000-10,000.

When sample ionized molecules have been obtained a preferred existing technique to determine the chemical bonding structure of the molecules is to fragment them by collisional ion dissociation, and then measure the mass of the fragments. A first mass spectrometer is used to select a parent ion of interest and the mass selected beam caused to impinge on a locally high density of background gas, usually comprising Argon or Helium. Fragments of the ion resulting from collision with a gas atom are then swept into a second mass spectrometer for analysis. There is, however, little finesse to this process as it is not possible to exercise control the way in which the ionized molecule fragments.

US 2004/0089804A1 discloses apparatus for use with laser ionization, the apparatus comprising a femtosecond laser, pulse shaper, MALDI-mass spectrometer and control system. It is envisioned in the application that the laser plays a more active and direct role in the ionization and even selective fragmentation of analyte proteins. This is apparently achieved by use of shaped femtosecond laser pulses determined by a search algorithm implemented by the control system. Pulse shapes are envisioned which include sequences of pulses where each pulse in the sequence plays a different role, for example melting, excitation, selective fragmentation, proton transfer and evaporation.

However, the application does not specifically disclose how this may be achieved with the disclosed apparatus. In particular no appreciation appears to have been made between the acts of ablation of sample molecules from a solid surface into the gas phase and the act of ionization, or, for that matter, ionization followed by dissociation.

Ablation of the surface and near surface layers of a sample requires a rapid, intense input of energy which has no chance of attaining thermodynamic equilibrium. This energy input is facilitated, in a MALDI process, because the matrix in the sample is chosen to absorb strongly at the frequency of the irradiating laser. In contrast, an ionizing laser pulse needs to be shaped to match the properties of the analyte molecule, indeed it is recognised in US2004/0089804A1 that in conventional MALDI the laser light suited to the chosen matrix molecules is completely unsuited to the ionization process.

### SUMMARY OF THE INVENTION

It is an object of the present invention to provide an improved apparatus and method for the analysis of molecules which addresses problems associated with the prior art.

According to a first aspect of the present invention there is provided apparatus for analysing molecules, the apparatus comprising: an ablation device for releasing a molecule from a sample to be analysed and a laser device for illuminating the released molecule with a shaped laser pulse to ionize and/or breakdown the molecule, wherein the ablation device or laser device has at least one component which is not shared by the other.

According to a second aspect of the present invention there is provided a method of analysing molecules comprising the steps of: releasing a molecule from a sample using an ablation device and illuminating the released molecule with a shaped laser pulse provided by a laser device, thereby to ionize and/or breakdown the molecule, wherein the ablation device or laser device has at least one component which is not shared by the other.

Use of differing ablation and laser devices to release and subsequently ionize molecules allows the ablation and ionization processes to be separated. Indeed, it is preferred that the ionization step takes place a predetermined time after the ablation step. This allows ionization to take place in the gas phase where the molecules are separated and various photon-molecule interactions are not present. Also, the most appropriate approach to ablation can be adopted.

The ablation device may operate to direct a beam onto the sample to release molecules from the sample. Any suitable beam may be employed, for example a laser beam to release molecules by laser ablation or matrix assisted laser desorption (MALDI) or an ion or neutral beam to release molecules by sputtering. Any convenient beam angle, to the surface, may be chosen. Typically the surface of the sample will intersect the ion optical axis of a mass spectrometer and most conveniently will extend in a plane generally perpendicular to that axis. The beam of the ablation device preferably lies off the ion optical axis of any mass spectrometer in which the sample is disposed.

The ablation device may comprise any suitable device. In one embodiment it is a sub picosecond laser. This may produce an unshaped pulse arranged to project an intense, sudden photon beam onto the sample. The sample may include a matrix material to make the ablation process more efficient. In another embodiment the ablation device comprises means to provide a primary ion beam or primary cluster ion beam, such as, for example, C₆₀⁺ or Au₃⁺⁺. The beam may be pulsed and then bunched to form a thin disk of charged particles, to produce an impact time of less than 100 picoseconds. Both of the above possible embodiments can ensure that the ablation plume is well defined in time.

Where the ablation device comprises a laser, this laser could also form part of the laser device. It is then required that one or other of the ablation and laser devices includes an additional component not shared by the other device.

For example, the ablation device may comprise a femtosecond laser and the laser device may comprise that laser and a pulse shaper. With this approach an unshaped laser pulse is employed to release molecules from the sample, and a shaped pulse to ionize the released molecules. Using the same laser to both release molecules from a sample and, in conjunction with a pulse shaper, to ionize those molecules (a pump probe system) allows for direct analysis of a sample with limited need for sample preparation. There is also the inherent efficiency of requiring only one laser.

The laser device preferably comprises a femtosecond laser and means for shaping pulses formed by the laser, for example a pulse shaper. The femtosecond pulse laser is preferably arranged to produce pulses of length 10-15 fs. The laser may produce of the order of 1000 pulses per second. A Ti Sapphire laser is suitable.

The shaped laser pulse for ionization of the released molecules may be comprised in a beam of pulses and is preferably directed along a path which is spaced apart from the region of the sample from which molecules are released. The path is preferably spaced from the surface of the entire sample, and may extend substantially parallel to the surface of the sample. The spacing of the path from the sample surface, and the timing of the shaped pulses relative to ablation of molecules from the sample, should be chosen so that released molecules will have traveled into the region of the path of the shaped pulse when the pulse is produced. Released molecules typically travel at a velocity of the order of 10³ MS⁻¹ and it is preferred that the shaped pulse is activated a few nano seconds after molecules are released. Therefore the pulsed beam should be spaced a few micro meters from the surface of the sample.

After sample molecules have been ionized the resulting ions may be subjected to a further shaped laser pulse arranged to selectively dissociate the ions. This further pulse is preferably spaced further from the sample than the pulse employed to ionize the molecules and the further pulse is preferably produced a period after the first pulse sufficient to allow the ionized molecules to travel into the path of the further pulse.

The further pulse may be produced by the laser device.

Produced ions and/or ion fragments are preferably swept into a mass spectrometer, which may be a time of flight mass spectrometer, for analysis.

The apparatus may further comprise a control means for controlling the laser means. The control means may comprise a programmable computer, such as a personal computer. The control means may implement a search algorithm, which may be a genetic algorithm. The search algorithm may be of the form described in US2004/0089804A1. The search algorithm may employ feed back to optimise shaping of the pulse. The algorithm may take account of the produced laser pulse as measured by an optical detector and/or on characteristics of detected ions released from a sample, as detected by an appropriate detector, for example comprised in a mass spectrometer, to aid in controlling shaping of laser pulses. Feed back from released ions enable pulse shaping to be optimised for production of particular ions, feed back from an optical detector enables pulse shaping to be optimised to produce a shaped pulse with desired characteristics.

Use of an appropriate search algorithm controlled laser pulse to ionize released molecules substantially increases the proportion of released molecules that are ionized, as compared to existing approaches. Further, it may be possible to select the manner of ionization.

Likewise, use of an appropriate search algorithm controlled laser pulse to break down ionized molecules can enable individual chemical bonds to be excited leading to fragmentation of a molecule in a predictable way.

In order that the invention may be more clearly understood embodiments thereof will now be described, by way of example, with reference to the accompanying drawings of which:

### BRIEF DESCRIPTION OF THE DRAWINGS

FIG. 1 is a schematic diagram of embodiments of apparatus according to the invention;

FIG. 2 is a schematic view of the region of a sample to be analysed by the apparatus of FIG. 1; and

FIG. 3 is a schematic diagram of an alternative embodiment of apparatus according to the invention.

### DETAILED DESCRIPTION OF THE PREFERRED EMBODIMENTS

Like reference numerals are used to refer to like, or equivalent, features throughout the drawings.

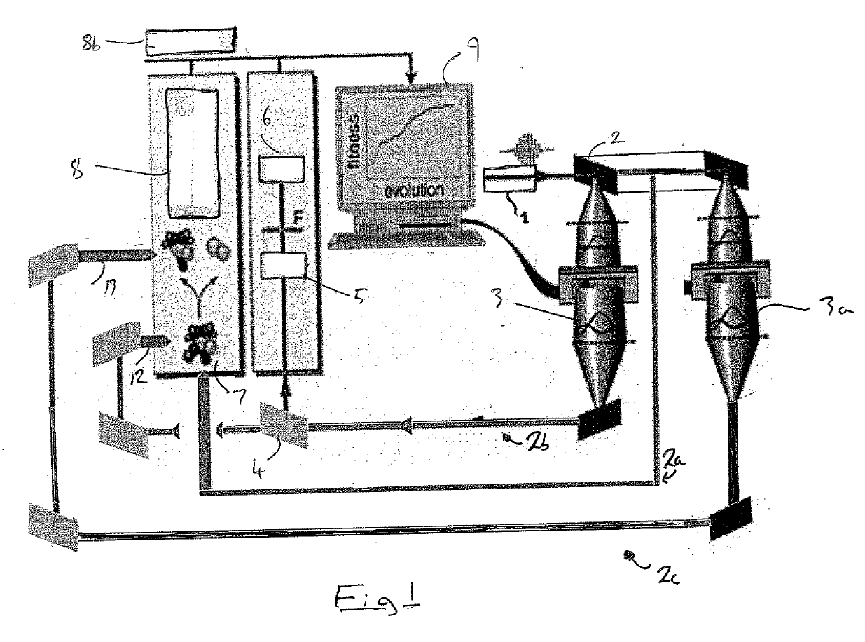

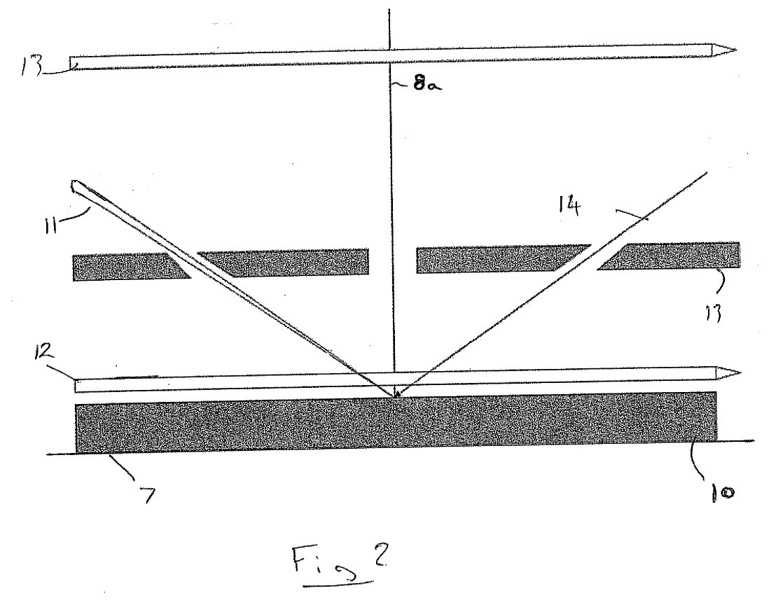

Referring to FIGS. 1 and 2 the apparatus comprises a Ti Sapphire femto-second pulsed laser 1. The laser produces pulses of length in the region of 10-50 femtoseconds, at the rate of about 1000 pulses per second. The pulses of this laser are directed to a splitter 2. The splitter 2 operates to direct the output of the laser 1 via one or more of first 2a and second 2b, and an optical third 2c, optical paths.

The first path 2a leads directly to a sample support 7, on which a sample 10 to be analysed is supported. The second path 2b passes through a femto-second pulse shaper 3 operative to produce phase and/or amplitude modulated laser pulses. The output of the pulse shaper 3 passes through a splitter 4 operative to direct a proportion of the beam into an optical detector comprising a second harmonic generator 5 and a photo diode 6.

The remainder of the beam is directed along a path extending across, and spaced apart from the sample support 7, and sample 10.

The sample support 7 is comprised in a time of flight mass spectrometer 8, incorporating a detector 9. The sample support extends substantially perpendicularly to the ion optical axis 8a of the mass spectrometer 8.

The various components of the apparatus are all operated under the control of a control means 9 comprising a programmable computer, such as a personal computer (PC), comprising the usual components of such apparatus including user operable controls, a processor, memory, visual display and appropriate software.

More specifically, the control means is operative to control the laser 1, pulse shaper 3 and various optical control elements so as to direct pulsed laser beams at or near the sample 10 supported on the sample support 7. Resultant signals produced by the detector 8b of the mass spectrometer, and the optical detector 5, 6, are fed back to the control means, forming a feedback loop. The incoming signal or signals are processed by the control means using a genetic search algorithm to optimise control of the laser and pulse shaper so as to generate shaped laser pulses optimised to ionize and/or dissociate sample molecules or ions in a predetermined way.

In use a sample 10, typically comprising complex molecules, is supported on the sample support 7.

The laser 1 is then operated under control of the control means 9, to produce an unshaped pulsed beam 11 which is directed by the splitter 2 via the first optical path 2a onto the sample 10 to ablate the sample. This releases molecules from the sample and these molecules travel from the surface of the sample, typically with a velocity of the order of 10³ MS⁻¹.

A predetermined time after release of molecules from the sample the control means causes the splitter 2 to direct the output of the laser 1 along the second optical path 2b via the pulse shaper 3 thereby to illuminate, and hence selectively ionize, the released molecules with shaped pulses. The path 12 of the shaped pulse extends over the surface of sample 10 a few micrometers above the surface. As such, the shaped pulses are produced the order of a few nanoseconds after release of molecules from the sample so that the molecules will have traveled into the path of the shaped pulse when the shaped pulse is produced. The path 12 of the shaped pulse over the surface of the sample 10 is substantially perpendicular to the ion optical axis 8a of the mass spectrometer 8.

The pulse shaper 3 operates under control of the control means 9 and comprises a grating and/or a crystal which is affected by an acoustic wave. Any appropriate pulse shaping technique could, though, be employed. The pulse shaper 3 is operative to modify a raw, unshaped, pulse produced by the laser 1 to produce a phase and/or amplitude shaped pulse.

Ionized molecules are swept into the mass spectrometer 8 by way of an electrode 13 and selected ions will impinge on the detector 8b of the mass spectrometer. The output of the detector is fed to the control means 9 enabling the control means 9 to control the pulse shaper 3, in dependence of the output of the detector, to optimize the shaped pulse beam in order to ionize the released molecules in a predetermined way.

Optionally the apparatus comprises a second optical pulse shaper 3a, disposed in a third optical path 2c from the laser 1, and via which the output of the femtosecond pulsed laser 1 can be directed, under control of the control means 9. The output of the second pulse shaper 3a is directed, via optical path 2e, along path 13 extending substantially perpendicularly over the ion optical axis 8a of the mass spectrometer and spaced away from the surface of the sample beyond the path 12 of the ionization beam and the electrode 13. This beam is arranged to illuminate ionized molecules as they travel parallel to the ion optical axis 8a in order to selectively dissociate the ionized molecules. Again, the control means 9 operates via a feedback loop to optimize shaping of the laser pulses so that the ionized molecules are dissociated in a predetermined way. When it is desired to provide a further beam to dissociate ionized molecules a second shaper 3a is required, since in practice it is not possible for a single pulse shaper to be reconfigured in the time interval between the first and second pulsed beams, given the expected different requirements of the pulsed beams for ionization and dissociation,

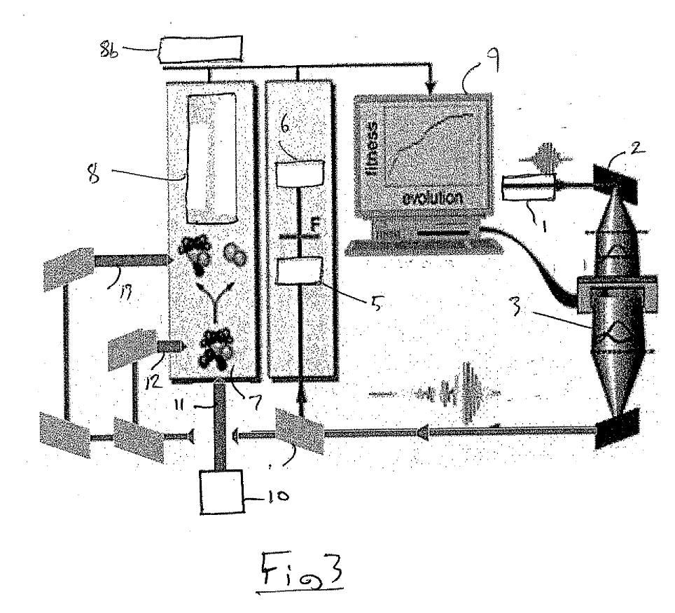

Referring to FIG. 3, in an alternative embodiment the first optical path from the laser 1 is omitted. Instead, means 10 to generate an ion or neutral beam 11 is provided. This beam is directed onto the sample 10 in order to release molecules from the sample. This embodiment could additionally include an optical splitter and second pulse shaper to provide second shaped pulse beam to dissociate ionized molecules, as illustrated in FIG. 1.

The above embodiments are described by way of example only. Many variations are possible without departing from the invention as defined by the following claims.

1. According to a first aspect of the present invention there is provided apparatus for analysing molecules, the apparatus comprising: an ablation device for releasing a molecule from a sample to be analysed and a laser device for illuminating the released molecule with a shaped laser pulse to ionize and/or breakdown the molecule, wherein the ablation device or laser device has at least one component which is not shared by the other.

2. Apparatus as claimed in claim 1 wherein the ablation device is arranged to direct a laser beam onto the sample to release molecules from the sample.

3. Apparatus as claimed in claim 2 wherein the ablation device comprises a sub picosecond laser.

4. Apparatus as claimed in claim 2 wherein the ablation device comprises a femtosecond laser.

5. Apparatus as claimed in claim 4 wherein the femtosecond laser is also comprised in the laser device.

6. Apparatus as claimed in claim 1 wherein the ablation device is arranged to direct an ion beam onto the sample to release molecules from the sample.

7. Apparatus as claimed in claim 6 wherein the ion beam is a cluster ion beam.

8. Apparatus as claimed in claim 1 wherein the ablation device is arranged to direct a neutral beam onto the sample ion beam onto the sample to release molecules from the sample.

9. Apparatus as claimed in claim 1 wherein the laser device comprises a femtosecond laser and a pulse shaper.

10. Apparatus as claimed in claim 1 comprising a sample support for supporting a sample to be analysed and wherein the laser device as arranged to direct the shaped pulse along a path which is spaced apart from the sample support, such that when a sample is present on the support a shaped laser pulse can be directed along a path which is spaced apart from the surface of the sample.

11. Apparatus as claimed in claim 10 wherein the path of the shaped pulse is arranged so that it extends substantially parallel to the surface of the sample.

12. Apparatus as claimed in claim 12 wherein the spacing of the path of the shaped pulse from the sample surface, and the timing of the shaped pulse relative to ablation of molecules from the sample, are arranged so that molecules released from the sample by the ablation device will have traveled into the path of the shaped pulse when the pulse is produced.

13. Apparatus as claimed in claim 1 comprising a second laser device, arranged to illuminate ionised molecules with a shaped laser pulse thereby to dissociate the ionised molecules.

14. Apparatus as claimed in claim 13 wherein the second laser device comprises a pulse shaper.

15. Apparatus as claimed in claim 13 wherein the shaped pulse produced by the laser device is arranged to travel along a path spaced from a sample being analysed and the shaped pulse produced by the second laser device is arranged to travel along a path which is spaced from the sample by a greater distance, but in the same general direction, as the path of the shaped pulse of the laser device.

16. Apparatus as claimed in claim 1 comprising a mass spectrometer for analysing ions released from the sample.

17. Apparatus as claimed in claim 1 comprising a control means for controlling the laser device.

18. Apparatus as claimed in claim 17 wherein the control means implements a feedback algorithm which employs measured characteristics of shaped laser pulse produced by the laser device and/or ions released from the sample.

19. A method of analysing molecules comprising the steps of: releasing a molecule from a sample using an ablation device and illuminating the released molecule with a shaped laser pulse provided by a laser device, thereby to ionize and/or breakdown the molecule, wherein the ablation device or laser device has at least one component which is not shared by the other.

20. A method as claimed in claim 19 wherein the step of releasing a molecule comprises directing a laser, ion or neutral beam at the sample using the ablation device.

21. A method as claimed in claim 19 wherein the shaped laser pulse is directed along a path which is spaced apart from the region of the sample from which molecules are released.

22. A method as claimed in claim 21 wherein the path extends substantially parallel to the surface of the sample.

23. A method as claimed in claim 21 wherein the spacing of the path from the sample surface, and the timing of the shaped pulses relative to ablation of molecules from the sample, are chosen so that released molecules will have traveled into the region of the path of the shaped pulse when the pulse is produced.

24. A method as claimed in claim 19 comprising the step of illuminating ionized molecules with a second shaped laser pulse thereby to dissociate the ionized molecules.

25. A method as claimed in claim 24 wherein the first laser pulse, to ionize released molecules, and the second laser pulse, to dissociate ionized molecules are differently shaped.

26. A method as claimed in claim 19 comprising the step of analysing ionized molecules with a mass spectrometer.

27. A method as claimed in claim 19 comprising the step of detecting the shaped laser pulse, and controlling the laser device in dependence on the detected pulse.

28. A method as claimed in claim 26 comprising the step of controlling the laser device in dependence on the output of the mass spectrometer.
